(19) United States
(12) Patent Application Publication
(10) Pub. No.: US 2023/0169009 A1
(43) Pub. Date: Jun. 1, 2023

(54) COMPUTATION PROCESSING APPARATUS AND METHOD OF PROCESSING COMPUTATION

(71) Applicant: FUJITSU LIMITED, Kawasaki-shi (JP)

(72) Inventors: YUKI KAMIKUBO, Yokohama (JP); Masakazu Tanomoto, Kawasaki (JP)

(73) Assignee: FUJITSU LIMITED, Kawasaki-shi (JP)

(21) Appl. No.: 17/875,456

(22) Filed: Jul. 28, 2022

(30) Foreign Application Priority Data
Nov. 29, 2021 (JP) 2021-193200

(51) Int. Cl. G06F 12/0875; G06F 9/445

(52) U.S. Cl. CPC G06F 12/0875; G06F 9/44552; G06F 2212/452; G06F 2212/603

(57) ABSTRACT

A computation processing apparatus that is able to execute threads, the apparatus includes: a cache including ways which respectively include storage areas identified by index addresses; and a processor coupled to the cache and configured to: determine a cache hit; hold a way number and an index address which identify a storage area holding target data of an atomic instruction executed by any one of the threads; determine a conflict between instructions in a case where a pair of the way number and the index address match a pair of a way number and an index address that identify a storage area that holds target data of a memory access instruction executed by an other one of the threads;

and suppress input and output of the target data of the memory access instruction to and from the cache when determining the conflict.

### CROSS-REFERENCE TO RELATED APPLICATION

This application is based upon and claims the benefit of priority of the prior Japanese Patent Application No. 2021-193200, filed on Nov. 29, 2021, the entire contents of which are incorporated herein by reference.

### FIELD

The embodiments discussed herein are related to a computation processing apparatus and a method of processing computation.

### BACKGROUND

A computation processing apparatus able to execute computation in multi-threads executes control to avoid conflict of data between the threads. For example, in the computation processing apparatus that includes a cache including a plurality of ways, a technique is known in which exclusive control of processing of threads is performed by comparing a way number held for each thread with a line number of the cache.

Japanese Laid-open Patent Publication No. 2006-155204, Japanese Laid-open Patent Publication No. 2015-38687, and International Publication Pamphlet No. WO 2012/098812 are disclosed as related art.

### SUMMARY

According to an aspect of the embodiments, a computation processing apparatus that is able to execute a plurality of threads, the apparatus includes: a cache including a plurality of ways which respectively include a plurality of storage areas identified by index addresses; and a processor coupled to the cache and configured to: determine a cache hit; hold a way number and an index address which identify a storage area holding target data of an atomic instruction executed by any one of the plurality of threads; determine a conflict between instructions in a case where a pair of the way number and the index address match a pair of a way number and an index address that identify a storage area that holds target data of a memory access instruction executed by an other one of the plurality of threads; and suppress input and output of the target data of the memory access instruction to and from the cache when determining the conflict.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a block diagram illustrating an example of a computation processing apparatus according to an embodiment;

FIG. 2 is a block diagram illustrating an example of a computation processing apparatus according to an other embodiment;

FIG. 3 is a flowchart illustrating an example of processing of an atomic instruction executed by the computation processing apparatus illustrated in FIG. 2;

FIG. 4 is a flowchart illustrating an example of a load process in step S20 illustrated in FIG. 3;

FIG. 5 is a flowchart illustrating an example of a store process in step S70 illustrated in FIG. 3;

FIG. 6 is a flowchart illustrating a continuation of the process illustrated in FIG. 5;

FIG. 7 is a flowchart illustrating a continuation of the process illustrated in FIG. 6;

FIG. 8 is an explanatory diagram illustrating an example of the processing of the atomic instruction and a load instruction executed by the computation processing apparatus illustrated in FIG. 2;

FIG. 9 is an explanatory diagram illustrating an example of processing of the atomic instruction and a store instruction executed by the computation processing apparatus illustrated in FIG. 2;

FIG. 10 is an explanatory diagram illustrating an other example of the processing of the atomic instruction and the store instruction executed by the computation processing apparatus illustrated in FIG. 2;

FIG. 11 is an explanatory diagram illustrating yet an other example of the processing of the atomic instruction and the store instruction executed by the computation processing apparatus illustrated in FIG. 2;

FIG. 12 is a circuit diagram illustrating an example of a lock determination circuit of the computation processing apparatus illustrated in FIG. 2;

FIG. 13 is a circuit diagram illustrating an example of a lock determination circuit of the computation processing apparatus illustrated in FIG. 2;

FIG. 14 is a block diagram illustrating an example of an other computation processing apparatus;

FIG. 15 is a flowchart illustrating an example of processing of the atomic instruction executed by the computation processing apparatus illustrated in FIG. 14;

FIG. 16 is a flowchart illustrating an example of the load process in step S20A illustrated in FIG. 15;

FIG. 17 is a flowchart illustrating an example of the store process in step S70A illustrated in FIG. 15;

FIG. 18 is a flowchart illustrating a continuation of the process illustrated in FIG. 17;

FIG. 19 is an explanatory diagram illustrating an example of the processing of the atomic instruction and the load instruction executed by the computation processing apparatus illustrated in FIG. 14;

FIG. 20 is an explanatory diagram illustrating an example of the processing of the atomic instruction and the store instruction executed by the computation processing apparatus illustrated in FIG. 14;

FIG. 21 is an explanatory diagram illustrating an other example of the processing of the atomic instruction and the store instruction executed by the computation processing apparatus illustrated in FIG. 14; and

FIG. 22 is an explanatory diagram illustrating yet an other example of the processing of the atomic instruction and the store instruction executed by the computation processing apparatus illustrated in FIG. 14.

### DESCRIPTION OF EMBODIMENTS

For example, an atomic instruction such as compare-and-swap (CAS) is used for exclusive control of the processing of the threads. Also in a multiprocessor system that includes a plurality of processors coupled to each other via a shared bus, exclusive control of threads executed by the respective processors is executed.

The computation processing apparatus able to execute a plurality of threads suppresses, in a case where an atomic instruction is executed by one of the threads, execution of a memory access instruction that is executed by an other thread and that conflicts with the atomic instruction until the atomic instruction is completed. For example, in a case where a memory access instruction that does not conflict with the atomic instruction is determined to conflict with the atomic instruction, the memory access instruction that normally does not necessarily wait is caused to wait until the completion of the atomic instruction. As a result, the execution efficiency of the memory access instruction degrades and the processing performance of the computation processing apparatus degrades.

In one aspect, an object of the present disclosure is to improve accuracy of determination of conflict between a memory access instruction and an atomic instruction and suppress degradation of processing performance of a computation processing apparatus.

Hereinafter, embodiments will be described with reference to the drawings. In the following, signal lines through which signals or other information are transmitted will be denoted by the same signs as those of signal names. Signal lines that are each represented by a single line in the drawings may include a plurality of bits.

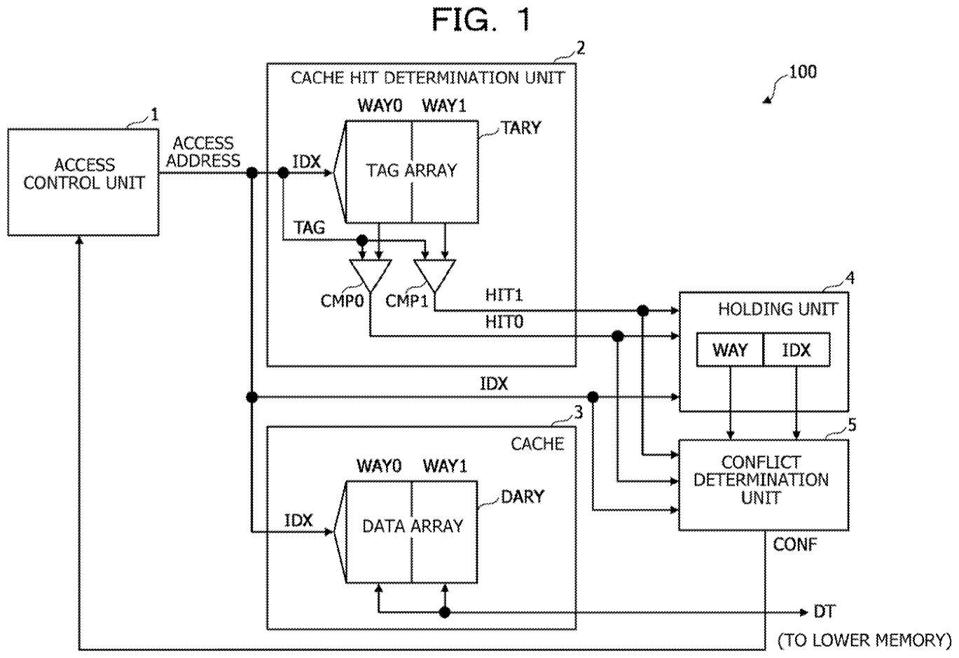

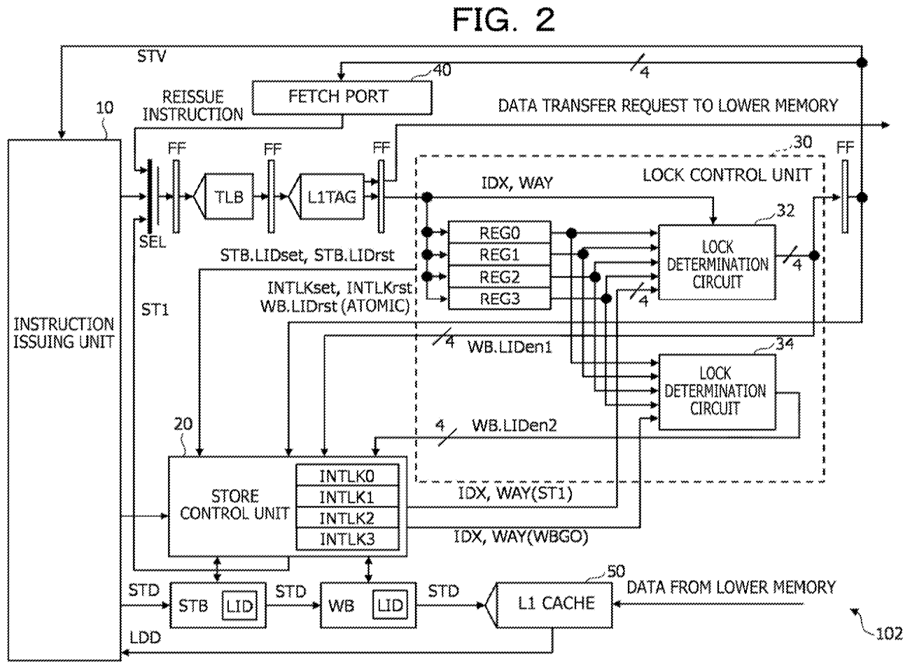

FIG. 1 illustrates an example of a computation processing apparatus according to an embodiment. A computation processing apparatus 100 illustrated in FIG. 1 is, for example, a processor such as a central processing unit (CPU) able to execute multi-thread computation. In multi-thread, a single process is divided into a plurality of threads (units of processing), and processing is executed in parallel. The computation processing apparatus 100 includes an access control unit 1, a cache hit determination unit 2, a cache 3, a holding unit 4, and a conflict determination unit 5. The computation processing apparatus 100 may include a store buffer STB and a write buffer WB illustrated in FIG. 2.

Based on a memory access instruction, an atomic instruction, or the like issued by an instruction issuing unit (not illustrated), the access control unit 1 outputs instruction information including an access address. For example, in a case where the atomic instruction is received, the access control unit 1 sequentially executes flows of a load process, a compare process, and a store process, which will be described later.

The cache hit determination unit 2 includes a TAG array TARY and comparators CMP0 and CMP1. For example, the TAG array TARY includes a plurality of ways WAY (WAY0 and WAY1). Each way WAY includes a plurality of entries that hold a plurality of tag addresses TAG corresponding to a plurality of index addresses IDX. Hereinafter, an index address IDX is also referred to as an index IDX, and a tag address TAG is also referred to as a tag TAG.

The index IDX is represented by a predetermined number of bits included in the access address. The tag TAG is represented by a predetermined number of bits that are included in the access address and different from the number of bits of the index IDX. For example, in a case where the index IDX is 8 bits, each of the ways WAY may store the tags TAG in 256 entries.

For each of ways WAY0 and WAY1, the tag array TARY reads the tags TAG from the entries corresponding to the index IDX included in the access address and outputs the tags TAG to the comparator CMP0 or CMP1. Each of the comparators CMP0 and CMP1 compares the tag TAG output from a corresponding one of ways WAY with the tag TAG included in the access address. In a case where the tags TAG match, one of the comparators CMP0 and CMP1 determines that data corresponding to the access address is held in the cache 3 (cache hit) and outputs a hit signal HIT (HIT0 or HIT1).

The cache 3 is, for example, a primary cache of a set associative method and includes a data array DARY. The data array DARY includes a plurality of ways WAY (WAY0 and WAY1) that hold data DT. Each way WAY of the data array DARY includes a plurality of entries that hold data corresponding to values of the plurality of index addresses IDX. For example, the cache 3 includes the plurality of ways WAY0 and WAY1 for each index IDX. For example, the data DT is a unit of input and output to and from a lower memory such as a secondary cache or main memory and is also referred to as a cache line.

The holding unit 4 holds the way WAY of the cache 3 in which the data is stored by the load process of the atomic instruction and the index IDX included in the access address of the atomic instruction. For example, the holding unit 4 holds the index IDX included in the access address based on the occurrence of the cache hit of an access-target access address in the load process of the atomic instruction. The holding unit 4 also holds the number of the way WAY of the tag array TARY that holds the tags TAG included in an access-target access address of the atomic instruction. Hereinafter, the number of the way WAY is also referred to as a way number WAY.

In a case where a compare process and a store process following the load process are completed in the atomic instruction, the way WAY and the index IDX held in the holding unit 4 are, for example, invalidated. Information held in the holding unit 4 may be invalidated by a value of a flag or by storing an invalid value in the holding unit 4. A period during which the valid way WAY and index IDX are held in the holding unit 4 corresponds to a lock period of the atomic instruction. The holding unit 4 may include a plurality of areas in which the ways WAY and the indices IDX are held corresponding to the respective threads executable in parallel.

The conflict determination unit 5 compares a pair of the way WAY of the cache 3 storing the access-target data DT corresponding to the access address and the index IDX included in the access address with a pair of the way WAY and the index IDX held in the holding unit 4. In a case where the former and the latter pairs of the way WAY and the index IDX match each other, the conflict determination unit 5 outputs to the access control unit 1 a conflict signal

CONF that is a logical value indicating a conflict. In a case where the former and the latter pairs of the way WAY and the index IDX do not match each other, the conflict determination unit 5 outputs to the access control unit 1 a conflict signal CONF that is a logical value not indicating a conflict. The comparison of the ways WAY is equivalent to a comparison of the tags TAG.

The access address includes, for example, the index address IDX, the tag address TAG, and an offset address. The offset address indicates a byte position of the data DT in a cache line, which is a unit of inputting and outputting the data to and from a lower memory. For this reason, in the case where the pairs of the index address IDX and the way WAY match each other, the conflict determination unit 5 may determine a conflict (data conflict) between the atomic instruction being locked and the memory access instruction executed in parallel with the atomic instruction.

By contrast, for example, in a case where a conflict is determined by comparing only the index addresses IDX without comparing the ways WAY, in some cases it is determined that a conflict with the atomic instruction is generated even though the tag addresses TAG do not match. In a case where execution of the memory access instruction is put on hold due to incorrect conflict determination, unnecessary wait time is generated and the processing performance of the computation processing apparatus 100 degrades.

In a case where a cache hit of the access address of the memory access instruction is determined by the cache hit determination unit 2, the access control unit 1 operates as follows in accordance with the conflict signal CONF. In a case where the conflict signal CONF does not indicate a conflict, the access control unit 1 inputs and outputs the data DT to and from the entry indicated by the index IDX in the way WAY of the cache 3 with which the cache hit occurs. For example, the data DT is read from the entry of the data array DARY by the load instruction, and the data DT is stored in the entry of the data array DARY by the store instruction. When the conflict signal CONF indicates a conflict, even in a case where the cache hit occurs with the cache 3, the access control unit 1 suppresses input and output of the data DT to and from the cache 3.

Thus, according to the present embodiment, access to the data DT held in the cache 3 corresponding to the access address being locked by the atomic instruction may be suppressed. Accordingly, reference to and update of the target data of an atomic process during the execution of the atomic instruction may be suppressed. In so doing, since the conflict determination unit 5 determines whether all the bits of the addresses (IDX, TAG) indicating the storage positions of the access-target data match, whether there is a conflict with the atomic instruction may be correctly determined. For example, accuracy of the determination of conflict between the memory access instruction and the atomic instruction may be improved. Accordingly, during the execution of the atomic instruction, reference to and update of the target data of the atomic process may be suppressed, and reference to and update of the data that is not target data of the atomic process may be carried out. As a result, putting execution of the memory access instruction on hold due to incorrect conflict determination may be suppressed, and degradation of the processing performance of the computation processing apparatus 100 may be suppressed.

FIG. 2 illustrates an example of a computation processing apparatus according to an other embodiment. Detailed description of elements similar to the elements of the above-described embodiment is omitted. A computation processing apparatus 102 illustrated in FIG. 2 is a processor such as a CPU able to execute multi-thread computation similarly to the computation processing apparatus 100 illustrated in FIG. 1. Although it is not particularly limited, for example, the computation processing apparatus 102 able to execute a maximum of four threads in parallel.

The computation processing apparatus 102 includes an instruction issuing unit 10, a store control unit 20, a lock control unit 30, a fetch port 40, and an L1 cache 50 (primary cache). The lock control unit 30 includes four registers REG (REG0, REG1, REG2, and REG3) and lock determination circuits 32, 34. The four registers REG respectively correspond to atomic instructions executed by four threads. The computation processing apparatus 102 also includes a selector SEL, a translation lookaside buffer (TLB), a tag L1TAG, a store buffer STB, and a write buffer WB. Vertically elongated rectangles illustrated in FIG. 2 indicate flip-flops FF. For example, a two-way set associative method is employed for the L1 cache 50.

The instruction issuing unit 10, the store control unit 20, and the fetch port 40 exemplify an access control unit that controls input and output of data to and from the L1 cache 50. The tag L1TAG is an example of a cache hit determination unit that determines the cache hit or the cache miss with the L1 cache 50. The registers REG are examples of a holding unit that holds the index addresses IDX and the way numbers WAY that identify storage areas of the L1 cache 50 in which target data of an atomic instructions, which will be described later, are held. The lock determination circuits 32 and 34 are examples of a conflict determination unit. Also, the lock determination circuit 32 is an example of a flag reset unit.

For example, the instruction issuing unit 10 decodes instructions received from an instruction buffer (not illustrated) and issues the decoded instructions. Examples of the instructions received by the instruction issuing unit 10 include various computation instructions, memory access instruction, atomic instruction, and so forth. According to the present embodiment, an example is described in which the instruction issuing unit 10 receives the memory access instruction and the atomic instruction. Accordingly, illustration of a circuit block related to execution of the computation instructions is omitted from FIG. 2.

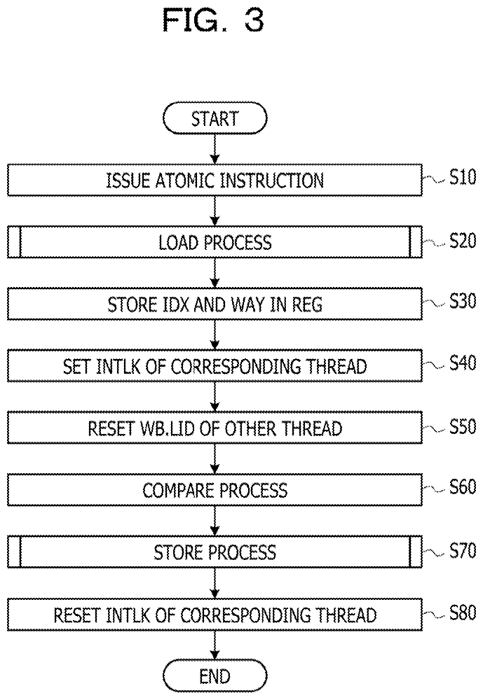

The memory access instruction is the load instruction or the store instruction. In a case where the instruction issuing unit 10 decodes the atomic instruction, the instruction issuing unit 10 sequentially issues the load instruction, the compare instruction, and the store instruction. The atomic instruction will be described with reference to FIG. 3.

The selector SEL selects, by using arbitration, one of an instruction decoded by the instruction issuing unit 10, an instruction put on hold output from the fetch port 40, and a direction of the start of a state ST1 of the store instruction, which will be described later, and the selector SEL outputs an address included in the selected instruction to the TLB. The TLB converts a virtual address output from the instruction issuing unit 10 into a physical address and outputs the converted physical address to the tag L1TAG. Hereinafter, the physical address is also simply referred to as an address.

Based on the address output from the TLB, the tag L1TAG determines the cache hit or the cache miss with the L1 cache 50. In a case where the cache hit is determined, the tag L1TAG notifies the lock control unit 30 of the index address IDX and the way number WAY.

In a case where the cache miss is determined, the tag L1TAG issues to a lower memory a transfer request for access-target data. In a case where the cache miss of the load instruction is determined, the tag L1TAG transfers to the fetch port 40 information for executing the load instruction. This causes execution of the load instruction to be put on hold until the data is transferred from the lower memory. The lower memory is, for example, a secondary cache, a main memory, or the like. The data transferred from the lower memory based on the transfer request from the tag L1TAG is stored in the L1 cache 50. The fetch port 40 holds the instruction put on hold transferred from the lock control unit 30 and reissues the held instruction to the selector SEL.

The store control unit 20 has four lock flags INTLK (INTLK0, INTLK1, INTLK2, and INTLK3) indicating that the atomic instructions are being locked (being executed) in four respective threads. The store control unit 20 receives information such as the address included in the store instruction from the instruction issuing unit 10 and holds the received information. The store control unit 20 receives from the tag L1TAG the way number WAY in which the target data of the store instruction having caused the cache hit is stored, and the store control unit 20 holds the received way number WAY. Based on information from the lock control unit 30, the store control unit 20 controls operation of the store buffer STB and the write buffer WB.

The store buffer STB includes a plurality of entries that have a first-in, first-out (FIFO) form and that hold LID flags and store data STD (including other information) received from the instruction issuing unit 10 that has decoded the store instruction. The store buffer STB is an example of a first buffer. The store data STD held in the store buffer STB is an example of first data. Each LID flag held in the store buffer STB is an example of a first flag. Based on a direction WBGO from the store control unit 20, the store buffer STB transfers the store data STD and the LID flags held in the entries to the write buffer WB.

The write buffer WB has a plurality of entries that have a FIFO format and that hold the LID flags and the store data STD transferred from the store buffer STB. The write buffer WB holds the store data STD and the LID flags transferred from the store buffer STB in the entries thereof.

The write buffer WB is an example of a second buffer. The store data STD held in the write buffer WB is an example of second data. Each of the LID flags held in the write buffer WB is an example of a second flag. The write buffer WB writes the store data STD held in the entries to the L1 cache 50 based on the control by the store control unit 20.

The L1 cache 50 includes a data array DARY similar to that of the cache 3 illustrated in FIG. 1. The L1 cache 50 is accessed in a case where the cache hit occurs with the instruction and the lock control unit 30 determines that there is no conflict with the atomic instruction. The L1 cache 50 reads data from the data array DARY (not illustrated) in the load instruction and outputs to the instruction issuing unit 10 the read data as data LDD. In a case where data is transferred from the store instruction or a lower memory, the L1 cache 50 writes the data to the data array DARY.

The lock control unit 30 stores the index IDX at the time of the cache hit caused by the atomic instruction and the way number WAY output from the tag L1TAG in the register REG corresponding to the thread that is executing the atomic instruction. Here, each thread does not simultaneously execute the atomic instruction and the load instruction or the store instruction.

Accordingly, the index IDX and the way number WAY are not held in the register REG corresponding to the thread that executes the load instruction or the store instruction.

The lock control unit 30 outputs to the store control unit 20 a direction STB.LIDset for setting a LID flag of the store buffer STB (STB.LID) in a case where the store instruction causes the cache hit in a state ST0 of the store instruction, which will be described later. Based on the direction STB.LIDset, the store control unit 20 sets to “1” the LID flag held in the entry together with store-target data in the store buffer STB. The lock control unit 30 outputs to the store control unit 20 a direction STB.LIDrst for resetting the LID flag of the store buffer STB in a case where the store instruction causes the cache miss in the state ST0. Based on the direction STB.LIDrst, the store control unit 20 resets to “0” the LID flag held in the entry together with store-target data in the store buffer STB.

In a case where the index IDX and the way number WAY are stored in the register REG corresponding to the thread that executes the atomic instruction, the lock determination circuit 32 outputs to the store control unit 20 a direction INTLKset for setting the lock flag INTLK corresponding to the thread. Based on the direction INTLKset, the store control unit 20 sets the corresponding lock flag INTLK.

The lock determination circuit 32 determines that the valid index IDX and the valid way number WAY are held in the register REG corresponding to the lock flag INTLK being set. The lock determination circuit 32 determines that the invalid index IDX and the invalid way number WAY are held in the register REG corresponding to the lock flag INTLK being reset.

Based on the completion of the atomic instruction, the lock determination circuit 32 outputs a direction INTLKrst for resetting the lock flag INTLK of the corresponding thread to the store control unit 20. Based on the direction INTLKrst, the store control unit 20 resets the corresponding lock flag INTLK. Thus, the lock determination circuit 32 may determine, on a thread-by-thread basis, whether the atomic instruction is locked based on the lock flag INTLK.

The lock determination circuit 32 receives a pair of the index IDX at the time of the cache hit caused by the load instruction and the way number

WAY output from the tag L1TAG. The lock determination circuit 32 compares the received pair of the index IDX and the way number WAY with a pair of the index IDX and the way number WAY held in the valid register REG to determine whether the former and the latter pairs match or do not match.

In a case where a match (conflict) is determined, the lock determination circuit 32 transfers the information for executing the load instruction to the fetch port 40 to suppress the execution of the load instruction. Thus, the execution of the load instruction determined to conflict with the atomic instruction is put on hold. In a case where a mismatch (no conflict) is determined, the lock determination circuit 32 outputs a read access request to the L1 cache 50 via a path (not illustrated) to execute the load instruction. In a case where the read access request is output to the L1 cache 50, the lock determination circuit 32 outputs a status valid (STV) signal to the instruction issuing unit 10 to cause the load instruction to be committed.

In a case where the index IDX and the way number WAY included in the atomic instruction are stored in the register REG, the lock determination circuit 32 outputs to the store control unit 20 a direction WB.LIDrst for resetting the LID flag of the write buffer WB (WB.LID). Based on the direction WB.LIDrst, the store control unit 20 resets to “0” the LID flag of the write buffer WB (WB.LID).

The lock determination circuit 32 receives a pair of the index IDX at the time of the cache hit caused by the store instruction and the way number WAY output from the tag L1TAG. The lock determination circuit 32 compares the received pair of the index IDX and the way number WAY with the pair of the index IDX and the way number WAY held in the valid register REG to determine whether the former and the latter pairs match or do not match.

In a case where a match (conflict) is determined with any one of the valid registers REG, the lock determination circuit 32 transfers the information for executing the store instruction to the fetch port 40 to suppress the execution of the store instruction. Thus, the execution of the store instruction determined to conflict with the atomic instruction is put on hold. In a case where mismatches with all the valid registers are determined, in order to continue the execution of the store instruction, the lock determination circuit 32 outputs the STV signal to the instruction issuing unit 10 to cause the store instruction to be committed.

The instruction issuing unit 10 commits the state ST0 of the store instruction based on the STV signal and outputs a commit notification to the store control unit 20. The store control unit 20 having received the commit notification transfers the store data STD and the LID flag held in the store buffer STB to the write buffer WB (WBGO).

In a case where the store instruction is in a cache hit state in the state ST1 of the store instruction, which will be described later, the lock determination circuit 32 receives the index address IDX and the way number WAY held by the store control unit 20 corresponding to the store instruction (IDX, WAY (ST1)). The lock determination circuit 32 compares the received pair of the index IDX and the way number WAY with the pair of the index IDX and the way number WAY held in the valid register REG to determine whether the former and the latter pairs match or do not match.

In the case where the lock determination circuit 32 determines a match (conflict) with any one of the valid registers REG, the lock determination circuit 32 outputs, to the store control unit 20, a direction WB.LIDen1 that suppresses setting of the LID flag of the entry of the write buffer WB (WB.LID). In the case where the lock determination circuit 32 determines mismatches with all the valid registers REG, the lock determination circuit 32 outputs, to the store control unit 20, the direction WB.LIDen1 that permits setting of the LID flag of the entry of the write buffer WB (WB.LID). Based on the direction WB.LIDen1, the store control unit 20 permits or suppresses the setting the LID flag of the write buffer WB (WB.LID).

After the state ST0 of the store instruction has been completed, the lock determination circuit 34 receives a pair of the index IDX and the way number WAY held by the store control unit 20 corresponding to the store instruction (IDX, WAY (WBGO)) before transition to the state ST1 is made. The sign WBGO indicates that the index IDX and the way number WAY output to the lock determination circuit 34 correspond to the store data STD or the like transferred from the store buffer STB to the write buffer WB. The lock determination circuit 34 compares the pair of the index IDX and the way number WAY received from the store control unit 20 with the pair of the index IDX and the way number WAY held in the valid register REG to determine whether the former and the latter pairs match or do not match.

In a case where the lock determination circuit 34 determines a match (conflict) with any one of the valid registers REG, the lock determination circuit 34 outputs, to the store control unit 20, a direction WB.LIDen2 that suppresses setting of the LID flag of the write buffer WB (WB.LID). In a case where the lock determination circuit 34 determines mismatches with all the valid registers REG, the lock determination circuit 34 outputs, to the store control unit 20, the direction WB.LIDen2 that permits setting of the LID flag of the write buffer WB (WB.LID) by using the LID flag transferred to the write buffer WB. Based on the direction WB.LIDen2, the store control unit 20 sets or suppresses the setting the LID flag of the write buffer WB (WB.LID).

FIG. 3 illustrates an example of processing of an atomic instruction executed by the computation processing apparatus 102 illustrated in FIG. 2. An operating flow illustrated in FIG. 3 starts based on the fact that the instruction issuing unit 10 decodes the atomic instruction. FIGS. 3 to 11 illustrate an example of a method of processing computation by using the computation processing apparatus 102.

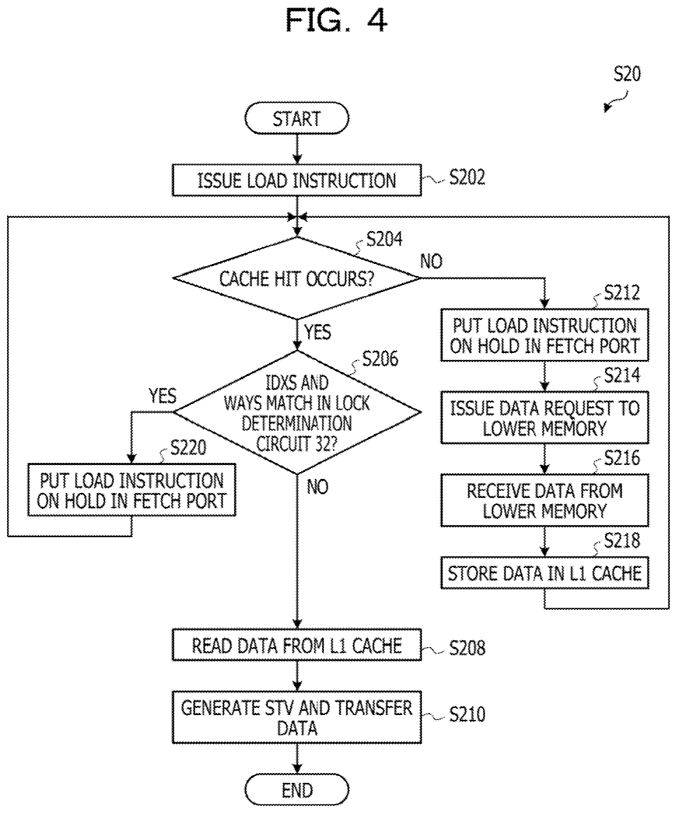

First, in step S10, the instruction issuing unit 10 issues the atomic instruction. Next, in step S20, the computation processing apparatus 102 executes the load process that is a first flow of the atomic instruction. An example of the load process is illustrated in FIG. 4.

Next, in step S30, the lock control unit 30 stores the way number WAY and the index IDX output from the tag L1TAG in the register REG corresponding to the thread that executes the atomic instruction. Next, in step S40, the computation processing apparatus 102 sets the lock flag INTLK corresponding to the thread that executes the atomic instruction, thereby setting the target data of the atomic instruction to a locked state.

Next, in step S50, the store control unit 20 resets the LID flag of the entry of the write buffer WB holding the store data STD of the thread other than the thread that is executing the atomic instruction.

Next, in step S60, the computation processing apparatus 102 executes a compare process that is a second flow of the atomic instruction. In the compare process, the computation processing apparatus 102 compares a value of the target data read in the load process with a value of the target data read in advance before the start of the atomic instruction. In a case where a comparison result indicates a match, the computation processing apparatus 102 executes step S70. Although it is not illustrated, in a case where the comparison result indicates a mismatch, there is a possibility that the target data has been rewritten by an other thread. Thus, the computation processing apparatus 102 ends the processing in FIG. 3.

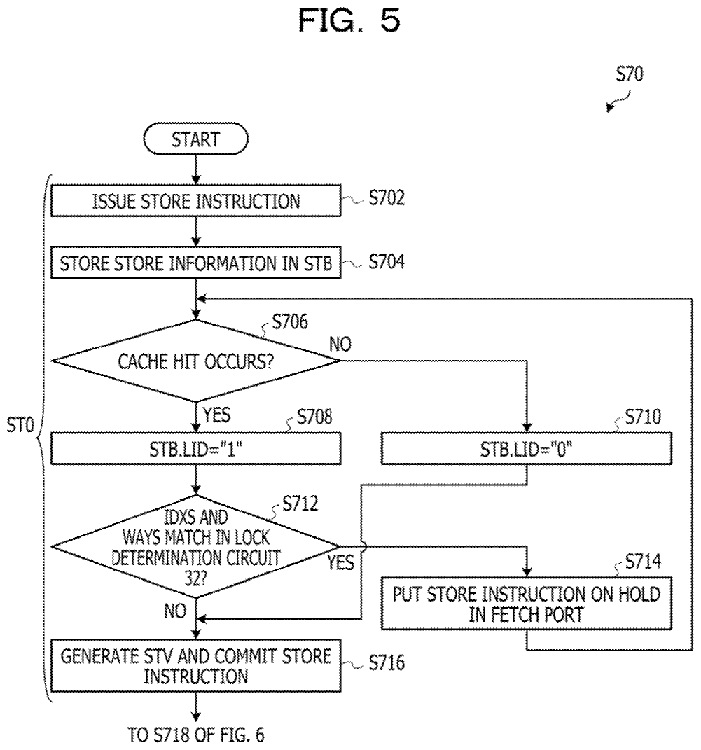

In step S70, the computation processing apparatus 102 executes the store process that is the last flow of the atomic instruction. An example of the store process is illustrated in FIGS. 5 to 7. Next, in step S80, the computation processing apparatus 102 resets the lock flag INTLK corresponding to the thread that executes the atomic instruction, thereby releasing the locked state of the target data of the atomic instruction and ending operation illustrated in FIG. 3.

FIG. 4 illustrates an example of the load process in step S20 illustrated in FIG. 3. A normal load instruction is executed similarly to that illustrated in FIG. 4.

First, in step S202, the computation processing apparatus 102 issues the load instruction from the instruction issuing unit 10. Next, in step S204, the computation processing apparatus 102 causes the tag L1TAG to determine the cache hit of the L1 cache 50 by using the physical address converted by the TLB. In the case where the cache hit is determined, the computation processing apparatus 102 executes step S206. In the case where the cache miss is determined, the computation processing apparatus 102 executes step S212.

In step S206, the computation processing apparatus 102 causes the lock determination circuit 32 to determine a match between the pairs of the indices IDX and the way numbers WAY. For example, the lock determination circuit 32 reads the pair of the index IDX and the way number WAY from the valid register REG corresponding to the lock flag INTLK being set. The lock determination circuit 32 determines whether the pair of the index IDX included in the load instruction and the number of way WAY holding the load-target data match the pair of the index IDX and the way number WAY read from the valid register REG.

In the case where the match is determined by the lock determination circuit 32, since the storage area of the load-target data is locked, the computation processing apparatus 102 executes step S220. In the case where the mismatch is determined by the lock determination circuit 32, since the storage area of the load-target data is not locked, the computation processing apparatus 102 executes step S208.

In step S220, the computation processing apparatus 102 puts the load instruction on hold in the fetch port 40, causes the fetch port 40 to reissue the load instruction, and returns the operation to step S204. In step S208, the computation processing apparatus 102 reads the load-target data from the L1 cache 50. Next, in step S210, the computation processing apparatus 102 causes the tag L1TAG to output the STV signal, outputs the data LDD read from the L1 cache 50 to the instruction issuing unit 10, and ends the load process illustrated in FIG. 4.

In contrast, in the case where the cache miss occurs, in step S212, the computation processing apparatus 102 puts the load instruction on hold in the fetch port 40 and causes the fetch port 40 to reissue the load instruction. Next, in step S214, the computation processing apparatus 102 requests the lower memory to read the target data of the load instruction. Next, in step S216, the computation processing apparatus 102 receives the target data of the load instruction from the lower memory. Next, in step S218, the computation processing apparatus 102 stores the data received from the lower memory in the L1 cache 50 and executes step S204 again to fetch the target data of the load instruction from the L1 cache 50.

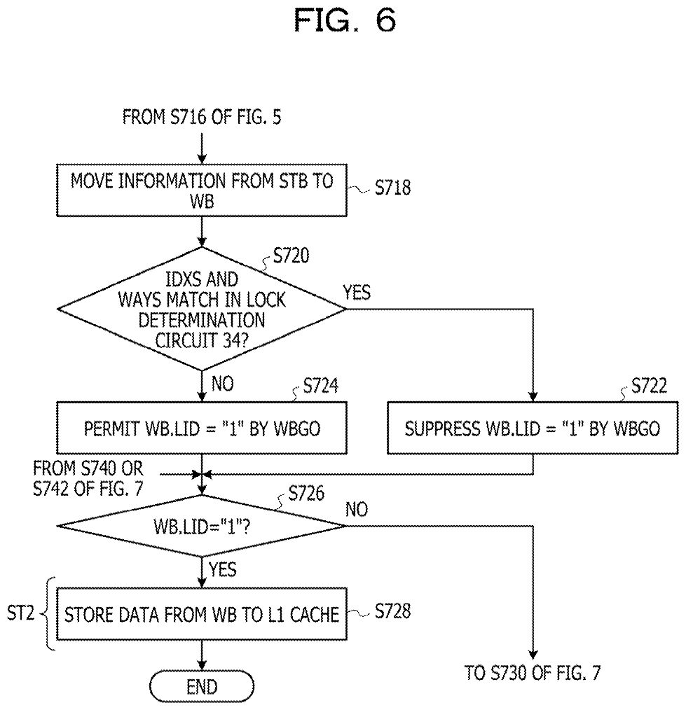

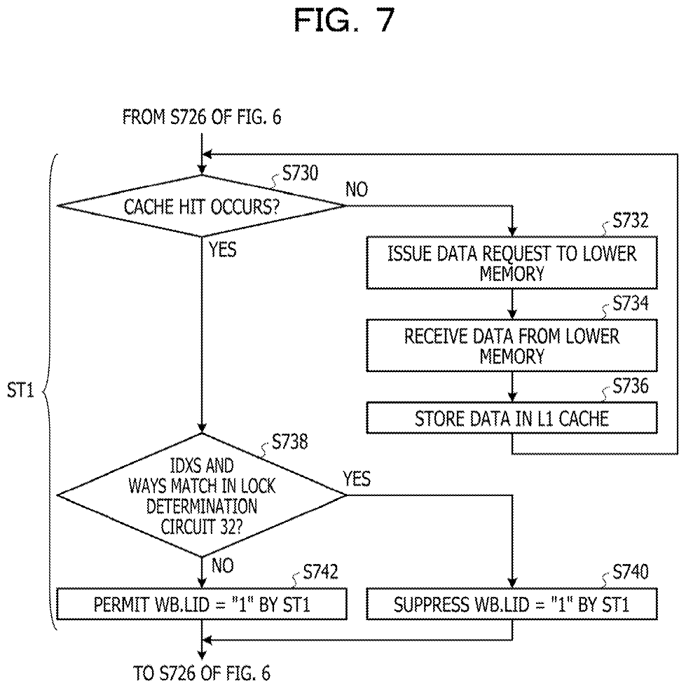

FIGS. 5 to 7 illustrate an example of the store process in step S70 illustrated in FIG. 3. A normal store instruction is executed similarly to a manner illustrated in FIGS. 5 to 7. Steps S702 to S716 illustrated in FIG. 5 illustrate an example of processing of the state ST0 of the store instruction. Steps S730 to S742 in FIG. 7 illustrate an example of processing of the state ST1 of the store instruction. Step S728 in FIG. 6 illustrates an example of processing of a state ST2 of the store instruction.

First, in step S702, the computation processing apparatus 102 issues the store instruction from the instruction issuing unit 10. Next, in step S704, the computation processing apparatus 102 causes information of the store instruction to be output from the instruction issuing unit 10 to the store control unit 20 and causes information such as the store data STD to be stored in the store buffer STB from the instruction issuing unit 10.

Next, in step S706, the computation processing apparatus 102 causes the tag L1TAG to determine the cache hit of the L1 cache 50 by using the physical address converted by the TLB. In the case where the cache hit is determined, the computation processing apparatus 102 executes step S708. In the case where the cache miss is determined, the computation processing apparatus 102 executes step S710.

In step S708, the computation processing apparatus 102 sets the LID flag of the store buffer STB to “1” and executes step S712. In step S710, the computation processing apparatus 102 resets the LID flag of the store buffer STB to “0” and executes step S716. The LID flag of “1” indicates that the L1 cache 50 holds data of a target area of the store instruction. The LID flag of “0” indicates that the L1 cache 50 does not hold the data of the target area of the store instruction.

In step S712, the computation processing apparatus 102 causes the lock determination circuit 32 to determine a match between the pairs of the indices IDX and the way numbers WAY. For example, the lock determination circuit 32 reads the pair of the index IDX and the way number WAY from the valid register REG corresponding to the lock flag INTLK being set. The lock determination circuit 32 determines whether the pair of the index IDX included in the store instruction and the number of way WAY holding the store-target data match the pair of the index IDX and the way number WAY read from the valid register REG.

In the case where the match is determined, since the storage area of the store-target data is locked by a conflicting atomic instruction, the computation processing apparatus 102 executes step S714. In the case where the mismatch is determined, since the storage area of the store-target data is not locked, the computation processing apparatus 102 executes step S716 to execute the state ST1 or state ST2, which will be described later.

As described above, in the case where the cache hit occurs in the state ST0 of the store instruction, the conflict with the atomic instruction may be correctly determined by comparing the pairs of the indices IDX and the way numbers WAY. Until the conflict with the atomic instruction is resolved, transfer of the data STD and the LID flag from the store buffer STB to the write buffer WB may be suppressed.

In step S714, the computation processing apparatus 102 puts the store instruction on hold in the fetch port 40, causes the fetch port 40 to reissue the store instruction, and returns the operation to step S706. In step S716, the computation processing apparatus 102 causes the tag L1TAG to output the STV signal, causes the instruction issuing unit 10 to commit the state ST0 of the store instruction, and executes step S718 illustrated in FIG. 6.

In step S718 illustrated in FIG. 6, the computation processing apparatus 102 controls the store control unit 20 to move the information including the LID flag held in the store buffer STB to the write buffer WB.

Next, in step S720, the computation processing apparatus 102 causes the lock determination circuit 34 to determine a match between the pairs of the indices IDX and the way numbers WAY. The lock determination circuit 34 reads the pair of the index IDX and the way number WAY from the valid register REG corresponding to the lock flag INTLK being set. The lock determination circuit 34 determines whether the pair of the index IDX included in the store instruction and the way number WAY output from the tag L1TAG match the pair of the index IDX and the way number WAY read from the valid register REG.

In the case where the match is determined, the computation processing apparatus 102 executes step S722. In the case where the mismatch is determined, the computation processing apparatus 102 executes step S724. In step S722, the computation processing apparatus 102 causes the store control unit 20 to suppress setting of the LID flag (WB.LID) to “1” in a case where the LID flag (STB.LID) of “1” is WBGO-transferred. After step S722, the computation processing apparatus 102 executes step S726.

In step S724, the computation processing apparatus 102 causes the store control unit 20 to permit setting of the LID flag (WB.LID) to “1” in a case where the LID flag (STB.LID) of “1” is WBGO-transferred. After step S724, the computation processing apparatus 102 executes step S726.

In step S726, the computation processing apparatus 102 causes the store control unit 20 to obtain the LID flag of the write buffer WB (WB.LID). The computation processing apparatus 102 executes step S728 in a case where the LID flag (WB.LID) is set to “1” and executes S730 illustrated in FIG. 7 in a case where the LID flag (WB.LID) is reset to “0”.

Even when the LID flag (STB.LID) is in the set state, in a case where the conflict with the atomic instruction is determined at the time of transferring the data STD from the store buffer STB to the write buffer WB, the setting of the LID flag (WB.LID) is suppressed. This may suppress transition from the state ST0 to the state ST2 without passing through the state ST1 described with reference to FIG. 7. For example, the conflict with the atomic instruction may be determined by using the processing of the state ST1.

In step S728, the computation processing apparatus 102 controls the store control unit 20 to store the data held in the write buffer WB to the L1 cache 50. In a case where there is no conflict with the atomic instruction and the cache hit state is assumed after the data STD and the LID flag have been transferred from the store buffer STB to the write buffer WB, the computation processing apparatus 102 may execute step S728. For example, the store data STD may be stored in the L1 cache 50 in the state 2 without executing the processing of the state ST1.

In step S730 illustrated in FIG. 7, the computation processing apparatus 102 causes the tag L1TAG to determine the cache hit with the L1 cache 50. In a case where the cache hit is determined, the computation processing apparatus 102 executes step S738. In a case where the cache miss is determined, the computation processing apparatus 102 executes step S732.

In step S732, the computation processing apparatus 102 requests that the lower memory reads the data stored in the target area of the store instruction. Next, in step S734, the computation processing apparatus 102 receives the data from the lower memory. Next, in step S736, the computation processing apparatus 102 stores the data received from the lower memory in the L1 cache 50 and executes step S730 again to store the target data of the store instruction in the L1 cache 50.

In step S738, the computation processing apparatus 102 causes the lock determination circuit 32 to determine a match between the pairs of the indices IDX and the way numbers WAY. The lock determination circuit 32 reads the pair of the index IDX and the way number WAY from the valid register REG corresponding to the lock flag INTLK being set. The lock determination circuit 32 determines whether the pair of the index IDX included in the store instruction and the way number WAY output from the tag L1TAG match the pair of the index IDX and the way number WAY read from the valid register REG.

In a case where the match is determined, since the storage area of the store-target data is locked, the computation processing apparatus 102 executes step S740. In a case where the mismatch is determined, since the storage area of the store-target data is not locked, the computation processing apparatus 102 executes step S742.

In step S740, the computation processing apparatus 102 causes the store control unit 20 to suppress setting of the LID flag of the write buffer WB (WB.LID) to “1”. After step S740, the computation processing apparatus 102 executes step S726 illustrated in FIG. 6. In step S742, the computation processing apparatus 102 causes the store control unit 20 to permit setting of the LID flag of the write buffer WB (WB.LID) to “1”. After step S742, the computation processing apparatus 102 executes step S726 illustrated in FIG. 6.

After the data STD and the LID flag have been transferred from the store buffer STB to the write buffer WB, in the state ST1, in a case of the cache miss state, the processing waits until the cache hit occurs, and the conflict with the atomic instruction is determined by the lock determination circuit 32. In a case where there is no conflict with the atomic instruction, setting of the LID flag (WB.LID) is permitted, and in a case of the cache hit state, the LID flag (WB.LID) is set. Thus, the state of the store instruction may be transitioned to the state ST2 in FIG. 6, and the store data STD held in the write buffer WB may be stored in the L1 cache 50. For example, only in the case where there is the cache hit and there is no conflict with the atomic instruction, the store data STD may be stored in the L1 cache 50, and store operation of the computation processing apparatus 102 may be normally executed.

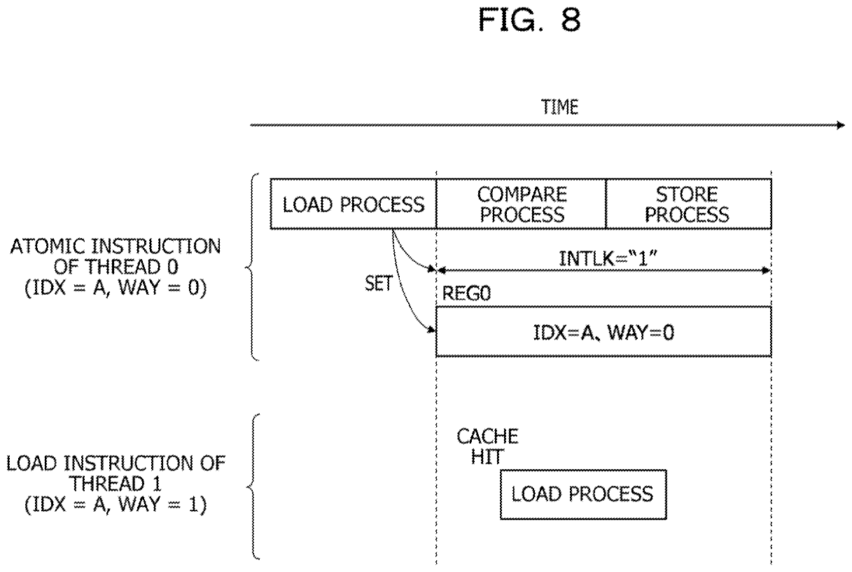

FIG. 8 illustrates an example of processing of the atomic instruction and the load instruction executed by the computation processing apparatus 102 illustrated in FIG. 2. In the example illustrated in FIG. 8, the atomic instruction of a thread 0 (index IDX=A, way number WAY=0) and the load instruction of a thread 1 (index IDX=A, way number WAY=1) are executed in parallel.

As illustrated in FIG. 3, the load process, the compare process, and the store process are sequentially executed in the atomic instruction. In the atomic instruction of the target thread 0, based on the completion of the load process, the index IDX=A and the way number WAY=0 are set in the register REG0 of the lock control unit 30, and the lock flag INTLK0 of the store control unit 20 is set to “1”. The lock flag INTLK0 is reset to “0” when the store process is completed.

For the load instruction (cache hit) of the thread 1, since the way number WAY is different from the way number WAY of the atomic instruction, the lock determination circuit 32 does not detect a conflict (determines the mismatch). Thus, the load instruction is not put on hold in the fetch port and is completed without waiting for the reset of the lock flag INTLK0 of the atomic instruction.

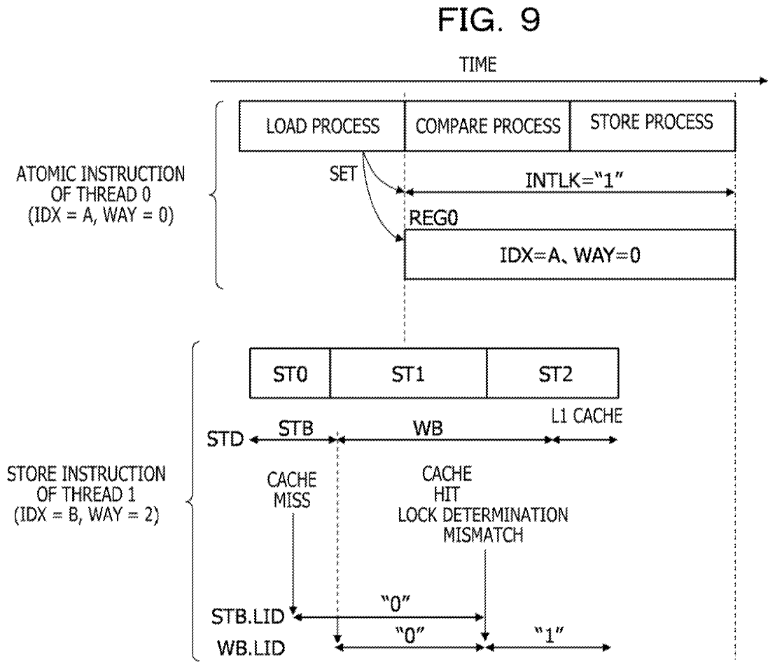

FIG. 9 illustrates an example of processing of the atomic instruction and the store instruction executed by the computation processing apparatus 102 illustrated in FIG. 2. In the example illustrated in FIG. 9, the atomic instruction of the thread 0 (index IDX=A, way number WAY=0) and the store instruction of the thread 1 (index IDX=B, way number WAY=2) are executed in parallel. The operation of the atomic instruction is similar to that illustrated in FIG. 8.

The store instruction of the thread 1 causes the cache miss in the state ST0, and the LID flag (STB.LID) is reset to “0”. Since the atomic instruction has not been locked yet, the processing of the state ST0 is normally executed and completed. During the processing of the state ST1, the atomic instruction is locked. In the state ST1, the data of the target area of the store instruction is transferred from the lower memory to the L1 cache 50, and the cache hit occurs with the L1 cache 50.

The lock determination circuit 32 detects a mismatch in lock determination and permits setting of the LID flag (WB.LID). Since the cache hit occurs in the state ST1, the store control unit 20 sets the LID flag (WB.LID) to “1” based on the permission from the lock determination circuit 32. Since there is no conflict with the atomic instruction, in the state ST2, the store data STD is stored in the L1 cache 50 without waiting for the reset of the lock flag INTLK0 of the atomic instruction. Then, the processing of the store instruction is completed.

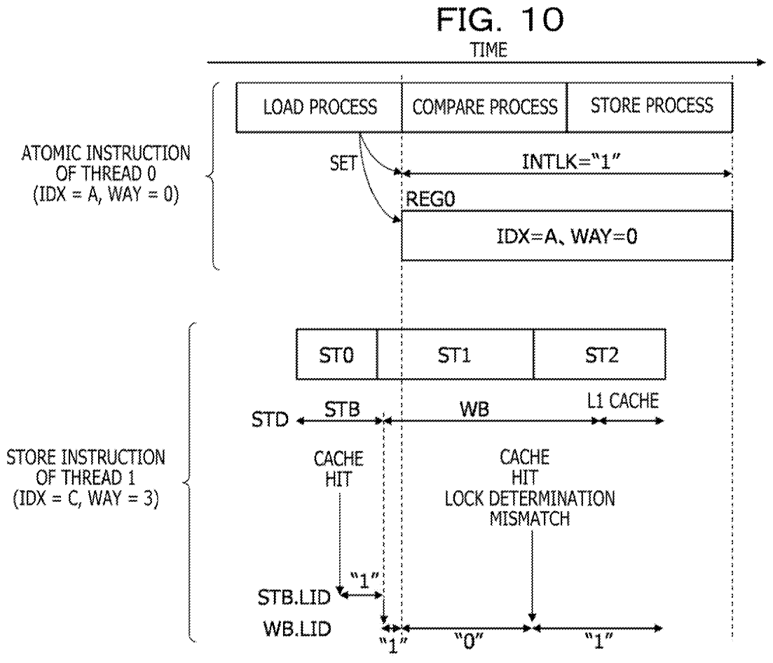

FIG. 10 illustrates an other example of the processing of the atomic instruction and the store instruction executed by the computation processing apparatus 102 illustrated in FIG. 2. In the example illustrated in FIG. 10, the atomic instruction of the thread 0 (index IDX=A, way number WAY=0) and the store instruction of the thread 1 (index IDX=C, way number WAY=3) are executed in parallel. The operation of the atomic instruction is similar to that illustrated in FIG. 8.

The store instruction of the thread 1 causes the cache hit in the state ST0, and the LID flag (STB.LID) is set to “1”. As the state transitions from the state ST0 to the state ST1, the store data STD is transferred to the write buffer WB, and the LID flag of the write buffer WB (WB.LID) is set to “1”. In this state, since the load process of the atomic instruction is completed, the LID flag (WB.LID) is reset to “0” by the atomic instruction.

Thus, because of the determination in step S726 illustrated in FIG. 6, the state of the store instruction is not shifted to the state ST2 but shifted to the state ST1. Accordingly, even in a case where the LID flag (STB.LID) in the set state is transferred from the store buffer STB to the write buffer WB, transition to the state ST1 may be performed before execution of the state ST2. As a result, the conflict with the atomic instruction may be determined by using the processing of the state ST1.

After that, as in FIG. 9, the lock determination circuit 32 detects a mismatch in the lock determination and sets the LID flag (WB.LID) to “1” by the cache hit. Since there is no conflict with the atomic instruction, in the state ST2, the store data STD is stored in the L1 cache 50 without waiting for the reset of the lock flag INTLK0 of the atomic instruction. Then, the processing of the store instruction is completed.

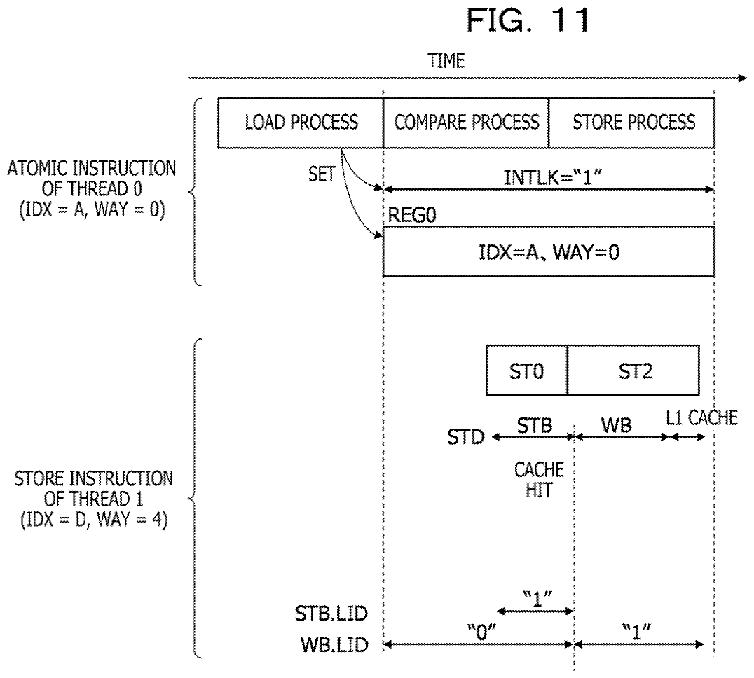

FIG. 11 illustrates yet an other example of the processing of the atomic instruction and the store instruction executed by the computation processing apparatus 102 illustrated in FIG. 2. In the example illustrated in FIG. 11, the atomic instruction of the thread 0 (index IDX=A, way number WAY=0) and the store instruction of the thread 1 (index IDX=D, way number WAY=4) are executed in parallel. The operation of the atomic instruction is similar to that illustrated in FIG. 8.

Referring to FIG. 11, the store instruction is executed while the atomic instruction being locked. In the state ST0, the store instruction of the thread 1 causes the cache hit, and the LID flag (STB.LID) is set to “1”. Thus, in the transition from the state ST0 to the state ST1, “1” of the LID flag (STB.LID) is moved to the LID flag (WB.LID). Accordingly, the state of the store instruction transitions to the state ST2 while the state ST1 being skipped. Since there is no conflict with the atomic instruction, in the state ST2, the store data STD is stored in the L1 cache 50 without waiting for the reset of the lock flag INTLK0 of the atomic instruction. Then, the processing of the store instruction is completed.

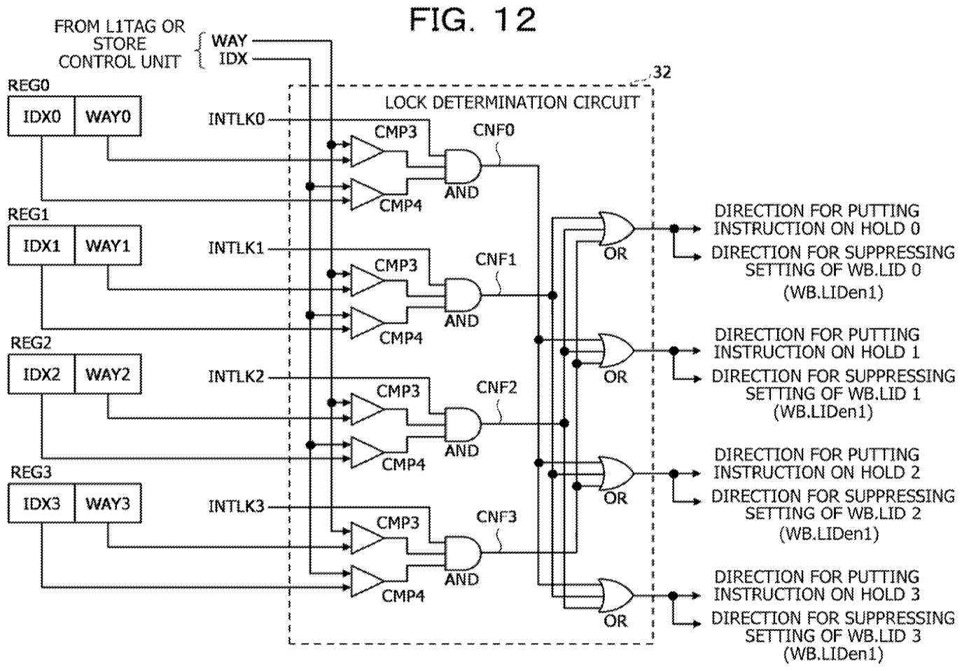

FIG. 12 illustrates an example of the lock determination circuit 32 of the computation processing apparatus 102 illustrated in FIG. 2. The lock determination circuit 32 includes a comparator CMP3 that compares the way number WAY from the tag L1TAG with the way number WAY of the register REG for each thread (for each register REG). The lock determination circuit 32 includes a comparator CMP4 that compares the INDEX IDX from the tag L1TAG with the INDEX IDX of the register REG for each thread.

The lock determination circuit 32 includes an AND circuit AND and an OR circuit OR for each thread. Each AND circuit AND sets a conflict signal CNF (CNF0, CNF1, CNF2, or CNF3) to “1” in a case where a comparison result of the comparators CMP3 is a match, a comparison result of CMP4 is a match, and the corresponding lock flag INTLK is set to “1”. Each AND circuit AND sets the corresponding conflict signal CNF to “0” in a case where any one of the comparison results of the comparators CMP3 and CMP4 is a mismatch or the corresponding lock flag INTLK is reset to “0”.

Each conflict signal CNF of “1” indicates that the target area of the memory access instruction of the corresponding thread is locked by the atomic instruction. Each conflict signal CNF of “0” indicates that the target area of the memory access instruction of the corresponding thread is not locked by the atomic instruction.

Each OR circuit OR issues a direction for putting the instruction of the corresponding thread on hold and the direction WB.LIDen1 for suppressing setting of the LID flag (WB.LID) of the corresponding thread in a case where at least one of the three conflict signals CNF corresponding to the other threads is “1”. The direction for putting the instruction of the corresponding thread on hold is issued to the fetch port 40, and the direction WB.LIDen1 for suppressing the setting of the LID flag (WB.LID) is issued to the store control unit 20.

Each OR circuit OR does not issue the direction for putting the instruction of the corresponding thread on hold and issues the direction WB.LIDen1 for permitting the setting of the LID flag (WB.LID) of the corresponding thread in a case where all the three conflict signals CNF corresponding to the other threads are “0”.

For example, in a case where the atomic instruction is executed in the thread 0 to cause a conflict with the load instruction of the thread 1, the conflict signal CONF0 is “1” and the conflict signals CONF1 to CONF3 are “0”. Output of the OR circuit OR corresponding to the thread 0 is “0” by “0” of the conflict signals CONF1 to CONF3.

Output of the OR circuits OR corresponding to the threads 1 to 3 is set to “1” by “1” of the conflict signal CONF0. In this example, since the load instruction is executed in the thread 1, a direction 1 for putting an instruction output from the OR circuit OR corresponding to the thread 1 on hold becomes valid, and the load instruction of the thread 1 may be put on hold.

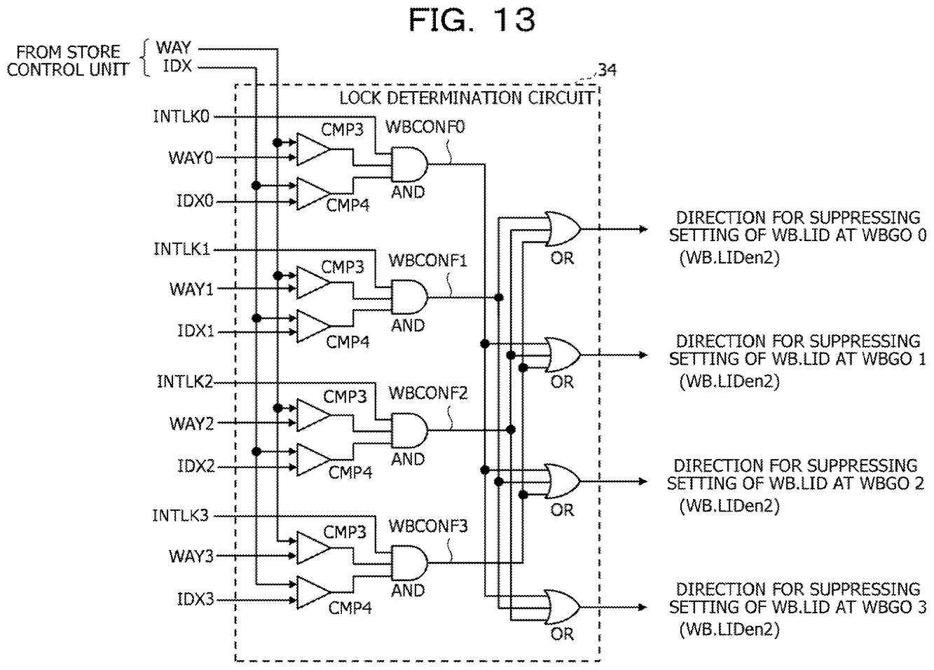

FIG. 13 illustrates an example of the lock determination circuit 34 of the computation processing apparatus 102 illustrated in FIG. 2. Detailed description is omitted for elements similar to those of the lock determination circuit 32 illustrated in FIG. 12. The lock determination circuit 34 has a similar logic to that of the lock determination circuit illustrated in FIG. 12 except for the difference in signal received by each comparator CMP3 and each comparator CMP4 and the difference in signal output by each AND circuit AND and each OR circuit OR.

Each comparator CMP3 compares the way number WAY (WBGO) from the store control unit 20 with the way number WAY from the register REG. Each comparator CMP4 compares the index IDX (WBGO) from the store control unit 20 with the index IDX from the register REG.

Each AND circuit AND outputs a conflict signal WBCNF (WBCNF0, WBCNF1, WBCNF2, or WBCNF3). Each AND circuit AND sets the corresponding conflict signal WBCNF to “1” in a case where a comparison result of the comparators CMP3 is a match, a comparison result of CMP4 is a match, and the corresponding lock flag INTLK is set to “1”.

Each OR circuit OR issues the direction WB.LIDen2 for suppressing setting of the LID flag (WB.LID) at the time of WBGO of the corresponding thread in a case where at least one of the three conflict signals WBCNF corresponding to the other threads is “1”. The direction WB.LIDen2 for suppressing the setting of the LID flag (WB.LID) is issued to the store control unit 20. Each OR circuit OR issues the direction WB.LIDen2 for permitting the setting of the LID flag (WB.LID) of the corresponding thread in a case where all the three conflict signals CNF corresponding to the other threads are “0”.

As described above, according to the present embodiment, effects similar to those of the above-described embodiment may be obtained. For example, the lock determination circuits 32 and 34 determine the match between the way number WAY and the index address IDX for identifying the storage position of the data in the L1 cache 50 in the atomic instruction and the memory access instruction. Thus, accuracy of the determination of conflict between the memory access instruction and the atomic instruction may be improved. Accordingly, during the execution of the atomic instruction, reference to and update of the target data of the atomic process may be suppressed, and reference to and update of the data that is not target data of the atomic process may be carried out. As a result, putting execution of the memory access instruction on hold due to incorrect conflict determination may be suppressed, and degradation of the processing performance of the computation processing apparatus 102 may be suppressed.

According to the present embodiment, in the case where the cache hit occurs in the state ST0 of the store instruction, the conflict with the atomic instruction may be correctly determined by comparing the pairs of the indices IDX and the way numbers WAY. Until the conflict with the atomic instruction is resolved, transfer of the data STD and the LID flag from the store buffer STB to the write buffer WB may be suppressed. Accordingly, the WBGO transfer may be controlled in accordance with the presence/absence of the conflict with the atomic instruction.

After the data STD and the LID flag have been transferred from the store buffer STB to the write buffer WB, in the state ST1, in the case where the LID flag (WB.LID) indicates the cache miss, the conflict with the atomic instruction is determined after waiting for the occurrences of the cache hit. In the case where there is no conflict with the atomic instruction, transition to the state ST2 may be performed by permitting the setting of the LID flag (WB.LID). Thus, the store data STD held in the write buffer WB may be stored in the L1 cache 50. For example, only in the case where there is the cache hit and there is no conflict with the atomic instruction, the store data STD may be stored in the L1 cache 50, and store operation of the computation processing apparatus 102 may be normally executed.

Even when the LID flag (STB.LID) is in the set state, in a case where the conflict with the atomic instruction is determined at the time of transferring the data STD from the store buffer STB to the write buffer WB, the setting of the LID flag (WB.LID) is suppressed. This may suppress transition from the state ST0 to the state ST2 without passing through the state ST1. For example, the conflict with the atomic instruction may be determined by using the processing of the state ST1.

The LID flag (WB.LID) is reset when the atomic instruction is executed. Accordingly, even in the case where the LID flag (STB.LID) in the set state is transferred from the store buffer STB to the write buffer WB, transition from the state ST0 to the state ST2 without passing through the state ST1 may be suppressed. As a result, as is the case with the above description, the conflict with the atomic instruction may be determined by using the processing of the state ST1.

Before the transition from the state ST0 to the state ST1, in a case where there is no conflict with the atomic instruction and the cache hit state is assumed, transition from the state ST0 to the state 2 may be performed without executing the processing of the state ST1, and the store data STD may be stored in the L1 cache 50.

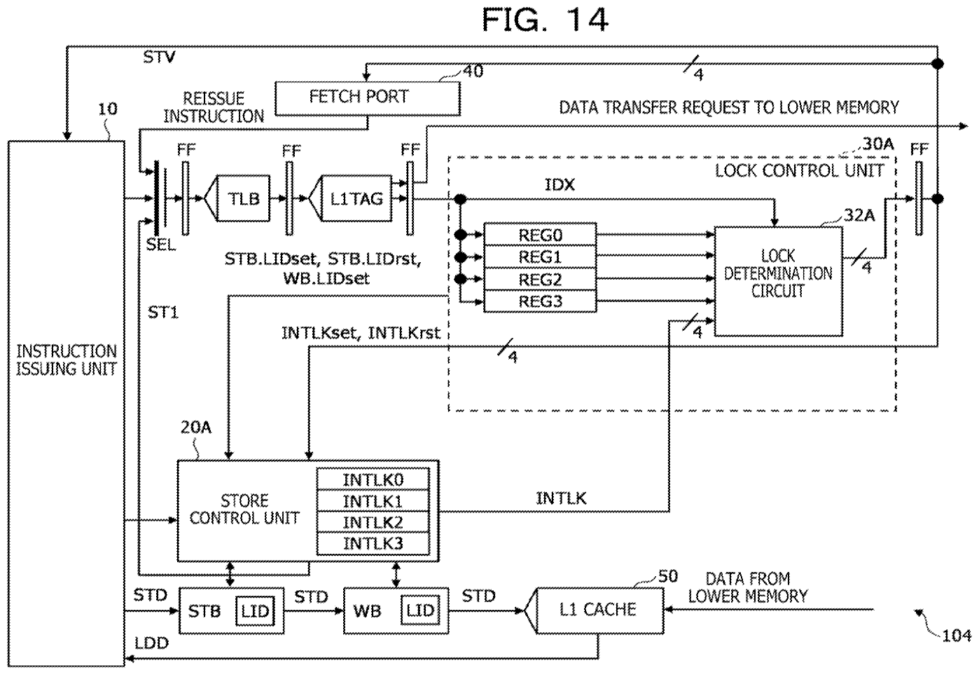

FIG. 14 illustrates an example of an other computation processing apparatus. Elements similar to those illustrated in FIG. 2 are denoted by the same signs, and detailed description thereof is omitted. A computation processing apparatus 104 illustrated in FIG. 14 includes a lock control unit 30A and a store control unit 20A instead of the lock control unit 30 and the store control unit 20 of the computation processing apparatus 102 illustrated in FIG. 2, respectively. The other configuration of the computation processing apparatus 104 is similar to that of the computation processing apparatus 102.

The lock control unit 30A includes a lock determination circuits 32A and the registers REG (REG0, REG1, REG2, and REG3) respectively corresponding to four threads. Each register REG stores the index IDX output from the tag L1TAG when the atomic instruction causes the cache hit. Unlike the registers REG illustrated in FIG. 2, each register REG does not store the way number WAY.

The lock control unit 30A outputs to the store control unit 20A the direction STB.LIDset for setting the LID flag of the store buffer STB (STB.LID) in a case where the store instruction causes the cache hit in the state ST0 of the store instruction. Based on the direction STB.LIDset, the store control unit 20A sets the LID flag held in the entry together with store-target data in the store buffer STB. The lock control unit 30A outputs to the store control unit 20A the direction STB.LIDrst for resetting the LID flag of the store buffer STB in a case where the store instruction causes the cache miss. Based on the direction STB.LIDrst, the store control unit 20A resets the LID flag held in the entry together with store-target data in the store buffer STB.

The lock control unit 30A outputs to the store control unit 20A the direction WB.LIDset for setting the LID flag of the write buffer WB (WB.LID) in the case where the store instruction causes the cache hit in the state ST1 of the store instruction, which will be described later. Based on the direction WB.LIDset, the store control unit 20A sets the LID flag held in the entry together with store-target data in the write buffer WB.

The lock determination circuit 32A receives the index IDX from the tag L1TAG, the index IDX from each register REG, and the lock flag INTLK from the store control unit 20A. In the case where the index IDX is stored in the register REG corresponding to the thread that executes the atomic instruction, the lock determination circuit 32A outputs to the store control unit 20A the direction INTLKset for setting the lock flag INTLK corresponding to the thread. Based on the direction, the store control unit 20A sets the corresponding lock flag INTLK.

The lock determination circuit 32A determines that the valid index IDX is held in the register REG corresponding to the lock flag INTLK being set. The lock determination circuit 32A determines that the invalid index IDX is held in the register REG corresponding to the lock flag INTLK being reset. Based on the completion of the atomic instruction, the lock determination circuit 32A outputs the direction INTLKrst for resetting the lock flag INTLK of the corresponding thread to the store control unit 20A. Based on the direction INTLKrst, the store control unit 20A resets the corresponding lock flag INTLK.

The lock determination circuit 32A receives the index IDX output from the tag L1TAG at the time of the cache hit caused by the load instruction.

The lock determination circuit 32A compares the received index IDX with the index IDX held in the valid register REG to determine whether the former and the latter match or do not match. In the case where the match (conflict) is determined, the lock determination circuit 32A transfers the information for executing the load instruction to the fetch port 40 to suppress the execution of the load instruction. In the case where the mismatch (no conflict) is determined, the lock determination circuit 32A outputs an access request to the L1 cache 50 via a path (not illustrated) to execute the load instruction. In the case where the access request is output to the L1 cache 50, the lock determination circuit 32A outputs the STV signal to the instruction issuing unit 10 to cause the load instruction to be committed.

In the state ST0 of the store instruction, the lock determination circuit 32A receives the index IDX output from the tag L1TAG at the time of the cache hit caused by the store instruction. The lock determination circuit 32A compares the received index IDX with the index IDX held in the valid register REG to determine whether the former and the latter match or do not match. In the case where the match (conflict) is determined with any one of the valid registers REG, the lock determination circuit 32A transfers the information for executing the store instruction to the fetch port 40 to suppress the execution of the store instruction. In the case where the mismatches with all the valid registers are determined, in order to continue the execution of the store instruction, the lock determination circuit 32A outputs the STV signal to the instruction issuing unit 10 to cause the store instruction to be committed.

As is the case with the store control unit 20 illustrated in FIG. 2, the store control unit 20A has four lock flags INTLK (INTLK0 to INTLK3) indicating that the atomic instructions are being locked (being executed) in four respective threads. The store control unit 20A receives information such as the address included in the load instruction or the store instruction from the instruction issuing unit 10 and holds the received information. The store control unit 20A receives from the tag L1TAG the way number WAY in which the target data of the load instruction or the store instruction having caused the cache hit is stored, and the store control unit 20A holds the received way number WAY. Based on information from the lock control unit 30A, the store control unit 20A controls the operation of the store buffer STB and the write buffer WB.

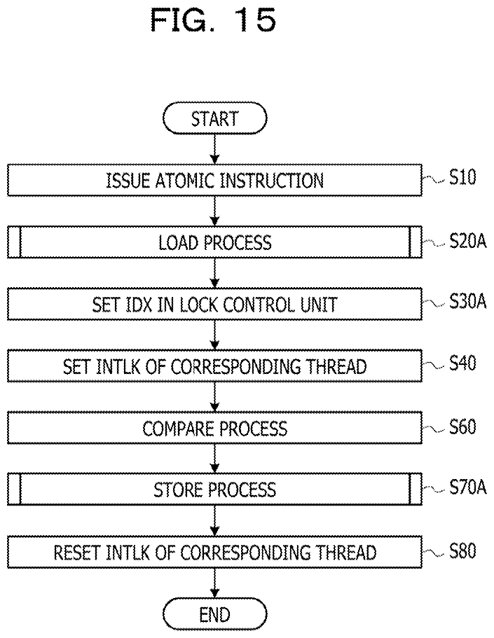

FIG. 15 illustrates an example of the processing of the atomic instruction executed by the computation processing apparatus 104 illustrated in FIG. 14. The detailed description of processing similar to that illustrated in FIG. 3 is omitted. An operating flow illustrated in FIG. 15 starts based on the fact that the instruction issuing unit 10 decodes the atomic instruction.

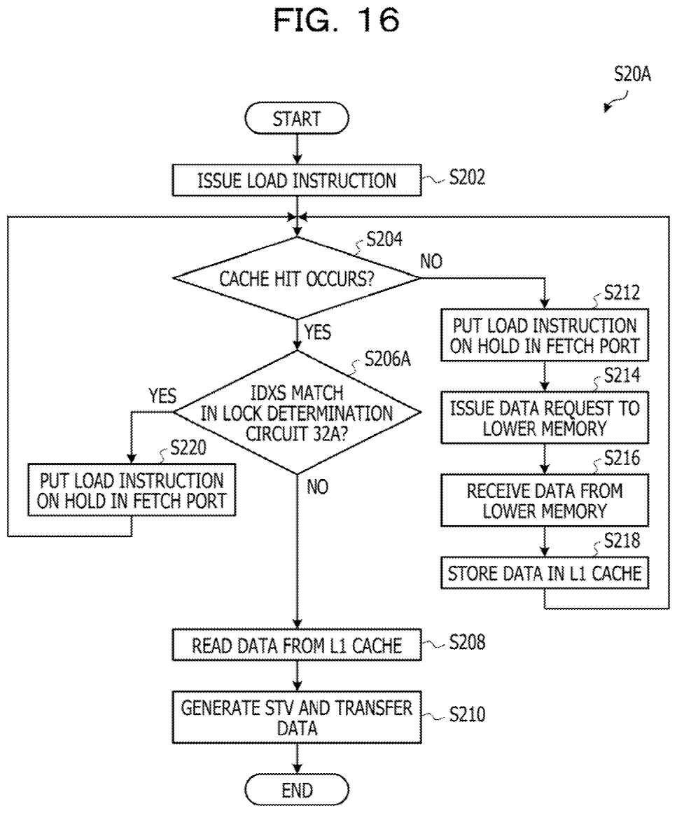

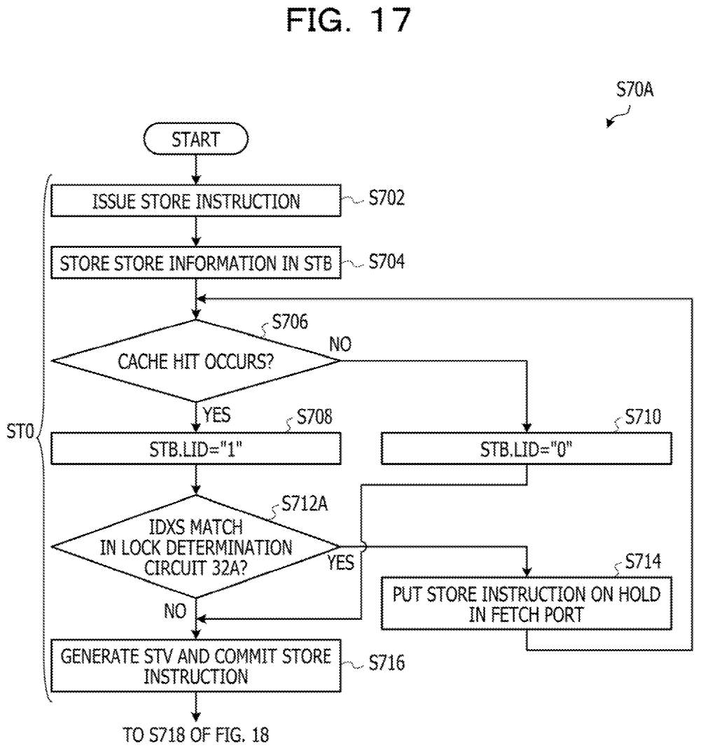

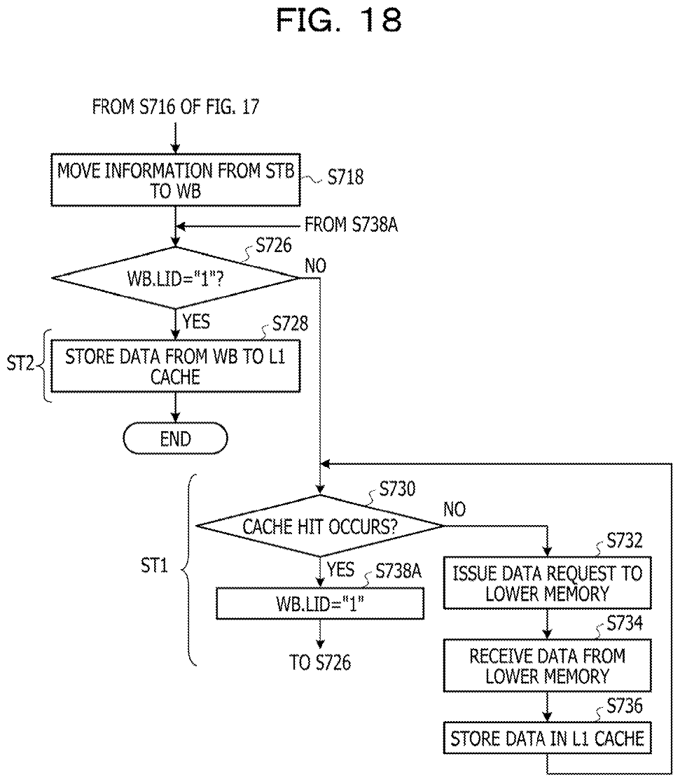

Referring to FIG. 15, steps S20A, S30A, and S70A are executed instead of steps S20, S30, and S70 illustrated in FIG. 3, and step S50 illustrated in FIG. 3 is not executed. Operation in steps S10, S40, S60, and S80, is similar to those in steps S10, S60, and S80 illustrated in FIG. 3. An example of the load process of step S20A is illustrated in FIG. 16. An example of the store process of step S70A is illustrated in FIGS. 17 and 18.

In step S30A, the lock control unit 30A stores the index IDX output from the tag L1TAG in the register REG corresponding to the thread that executes the atomic instruction.

FIG. 16 illustrates the example of the load process in step S20A illustrated in FIG. 15. Operation similar to that illustrated in FIG. 4 is denoted by the same step numbers and detailed description thereof is omitted. The load process illustrated in FIG. 16 is similar to the load process illustrated in FIG. 4 except for that step S206A is executed instead of step S206 illustrated in FIG. 4.

In step S206A, the computation processing apparatus 104 causes the lock determination circuit 32A to determine the match between the indices

IDX. The lock determination circuit 32A reads the index IDX from the valid register REG corresponding to the lock flag INTLK being set. The lock determination circuit 32A determines whether the index IDX included in the load instruction matches the index IDX read from the valid register REG. Thus, the lock determination circuit 32A determines the conflict with the atomic instruction based only on the indices IDX without comparing the way numbers WAY in the load instruction.

In the case where the match is determined, since the storage area of the load-target data is locked, the computation processing apparatus 104 executes step S220. In the case where the mismatch is determined, since the storage area of the load-target data is not locked, the computation processing apparatus 104 executes step S208.

FIGS. 17 and 18 illustrate the example of the store process in step S70A illustrated in FIG. 15. Operation similar to that illustrated in FIGS. 5 to 7 is denoted by the same step numbers and detailed description thereof is omitted.

The store process illustrated in FIG. 17 is similar to the store process illustrated in FIG. 5 except for that step S712A is executed instead of step S712 illustrated in FIG. 5. The store process illustrated in FIG. 18 is similar to the store process illustrated in FIGS. 6 and 7 except for that steps S720, S724, and S722 in FIG. 6 and steps S738, S740, and S742 in FIG. 7 are deleted and step S738A is added.

In step S712A illustrated in FIG. 17, the computation processing apparatus 104 causes the lock determination circuit 32A to determine the match between the indices IDX. The lock determination circuit 32A reads the index IDX from the valid register REG corresponding to the lock flag INTLK being set. The lock determination circuit 32A determines whether the index IDX included in the store instruction matches the index IDX read from the valid register REG. Thus, the lock determination circuit 32A determines the conflict with the atomic instruction based only on the indices IDX without comparing the way numbers WAY in the store instruction.

In the case where the match is determined, since the storage area of the store-target data is locked, the computation processing apparatus 104 executes step S714. In the case where the mismatch is determined, since the storage area of the store-target data is not locked, the computation processing apparatus 104 executes step S716.

Referring to FIG. 18, step S726 is executed after step S718, and in the case where the cache hit is determined in step S730, step S738A is executed. In step S738A, the computation processing apparatus 104 causes the store control unit 20A to set the LID flag of the write buffer WB (WB.LID) to “1”. After step S738A, the computation processing apparatus 104 returns to step S726.

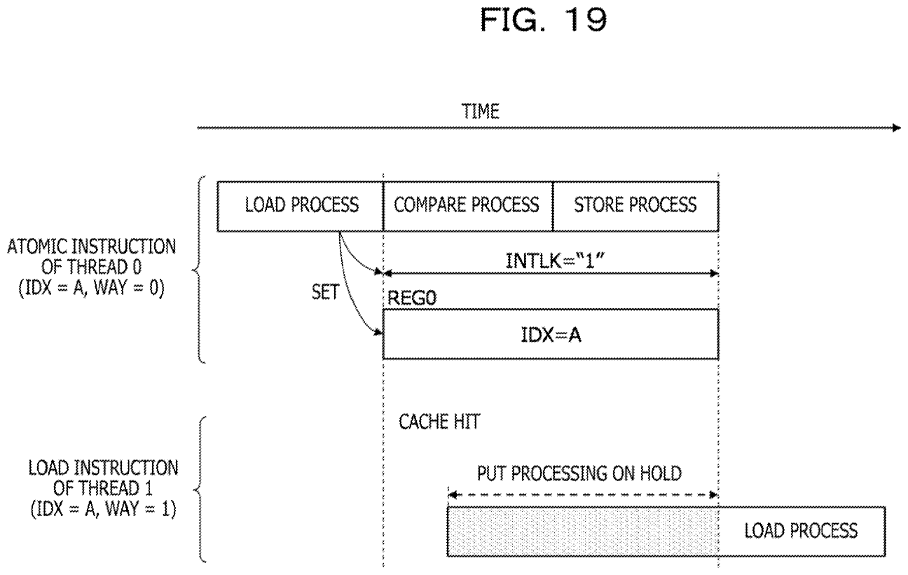

FIG. 19 illustrates an example of processing of the atomic instruction and the load instruction executed by the computation processing apparatus 104 illustrated in FIG. 14. Detailed description of operation similar to that illustrated in FIG. 8 is omitted. The operation of the atomic instruction is similar to that illustrated in FIG. 8.

The index IDX of the load instruction of the thread 1 matches that of the atomic instruction, and the way number WAY of the load instruction of the thread 1 is different from that of the atomic instruction. Since the way number WAY of the atomic instruction is different, the lock determination circuit 32A detects the conflict between the load instruction and the atomic instruction (determination of matching). Actually, in the case where the way number WAY is different, the conflict with the atomic instruction does not occur.

However, the lock determination circuit 32A illustrated in FIG. 14 determines the conflict between the load instruction and the atomic instruction and puts the load instruction on hold in the fetch port. The load instruction is executed after the completion of the atomic instruction. Accordingly, although no conflict occurs, the load instruction is put on hold, and the processing performance of the computation processing apparatus 104 degrades.

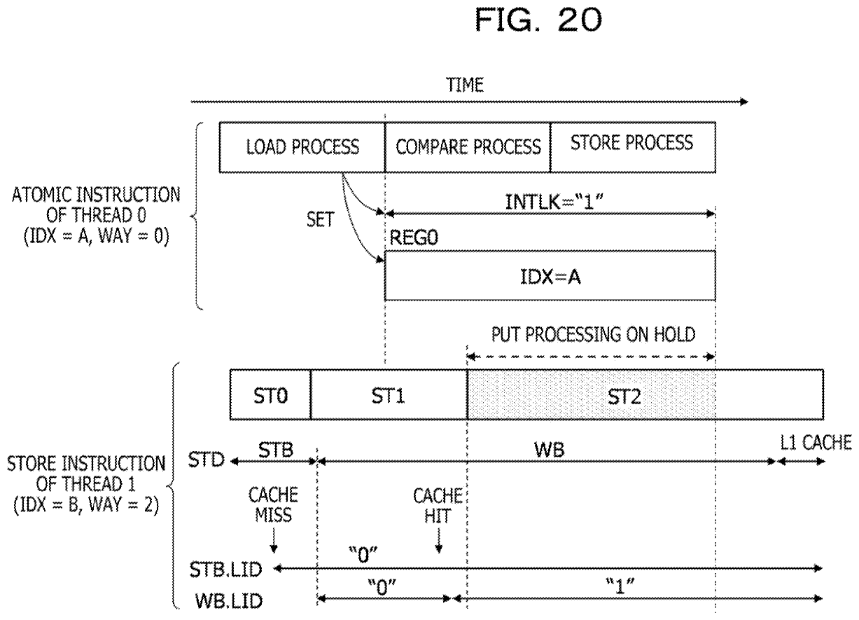

FIG. 20 illustrates an example of processing of the atomic instruction and the store instruction executed by the computation processing apparatus 104 illustrated in FIG. 14. Detailed description of operation similar to that illustrated in FIG. 9 is omitted. The operation of the atomic instruction is similar to that illustrated in FIG. 19. Operation up to the state ST1 of the store instruction of the thread 1 is similar to that illustrated in FIG. 9.

In the state ST0 of the store instruction of the thread 1, the cache miss occurs, and accordingly, the LID flag (STB.LID) is reset to “0”. The index IDX of the store instruction is different from that of the atomic instruction. Thus, the lock determination circuit 32A detects that the store instruction and the atomic instruction do not conflict with each other in the state ST0 (determines the mismatch) and causes the state of the store instruction to transition to the state ST1.

In the state ST1, the store control unit 20A sets the LID flag (WB.LID) to “1” based on the cache hit of the store instruction, and the state of the store instruction transitions to the state ST2. However, since the atomic instruction is being locked, the processing in the state ST2 of the store instruction is put on hold until the locking of the atomic instruction is released. Although no conflict occurs, the load instruction is put on hold, and accordingly, the processing performance of the computation processing apparatus 104 degrades.

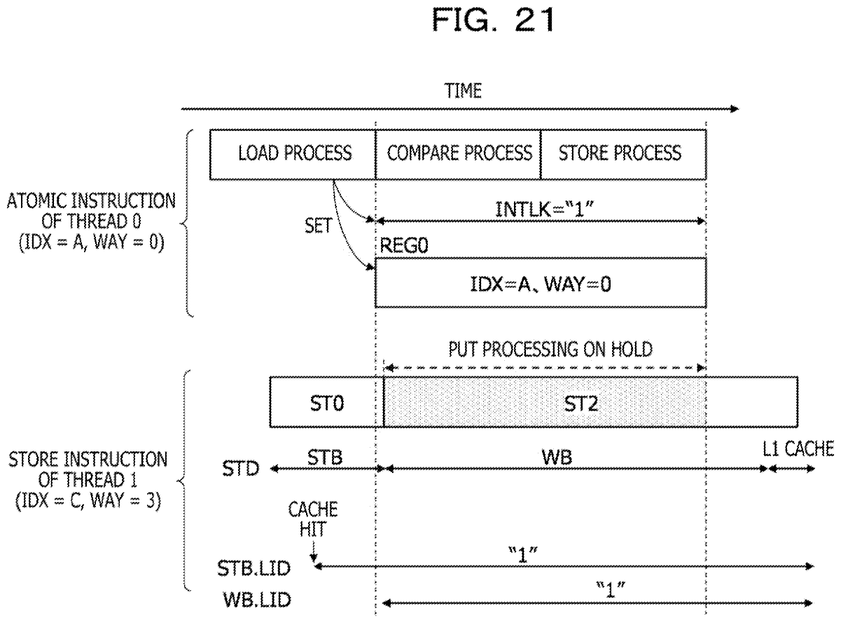

FIG. 21 illustrates an other example of the processing of the atomic instruction and the store instruction executed by the computation processing apparatus 104 illustrated in FIG. 14. Detailed description of operation similar to that illustrated in FIG. 10 is omitted. The operation of the atomic instruction is similar to that illustrated in FIG. 19. Operation in the state ST0 of the store instruction of the thread 1 is similar to that illustrated in FIG. 10.

The store instruction of the thread 1 causes the cache hit in the state ST0, and the LID flag (STB.LID) is set to “1”. The index IDX of the store instruction is different from that of the atomic instruction. Thus, the lock determination circuit 32A detects that the store instruction and the atomic instruction do not conflict with each other in the state ST0 (determines the mismatch).

At the end of the state ST0, the LID flag (STB.LID)=“1” is moved to the LID flag (WB.LID). Accordingly, the state of the store instruction transitions to the state ST2 without passing through the state ST1. When the state transitions from the state ST0 to state ST2, since the atomic instruction is being locked, the processing in the state ST2 of the store instruction is put on hold until the locking of the atomic instruction is released. Although no conflict occurs, the load instruction is put on hold, and accordingly, the processing performance of the computation processing apparatus 104 degrades.

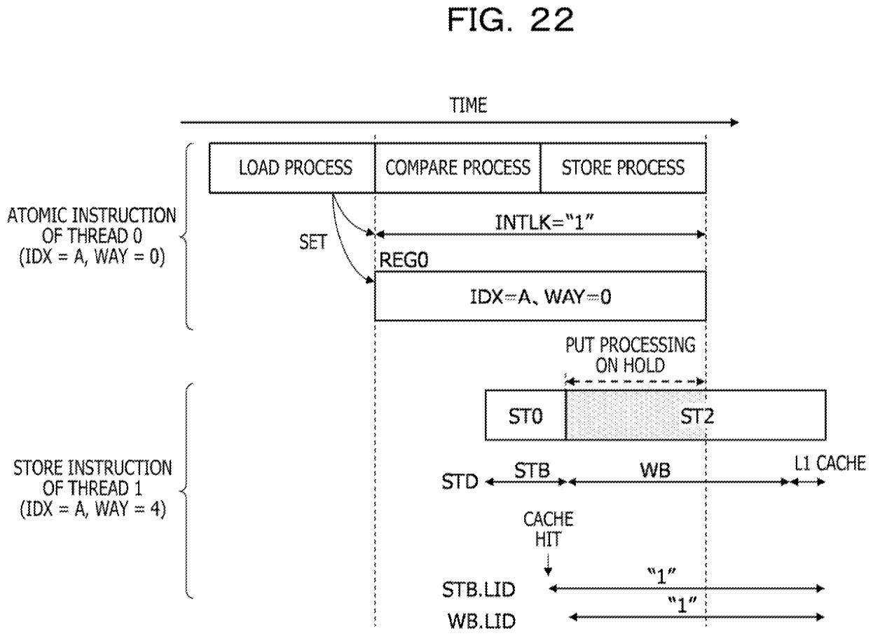

FIG. 22 illustrates yet an other example of the processing of the atomic instruction and the store instruction executed by the computation processing apparatus 104 illustrated in FIG. 14. Detailed description of operation similar to that illustrated in FIG. 11 is omitted. The operation of the atomic instruction is similar to that illustrated in FIG. 19. Operation in the state ST0 of the store instruction of the thread 1 is similar to that illustrated in FIG. 11.

Operation illustrated in FIG. 22 is similar to the operation illustrated in FIG. 21 except for that the atomic instruction is locked before the start of the store instruction. Since the index IDX of the store instruction is different from that of the atomic instruction, the lock determination circuit 32A detects that the store instruction and the atomic instruction do not conflict with each other.

At the end of the state ST0, since the LID flag (STB.LID)=“1” is moved to the LID flag (WB.LID), the state of the store instruction transitions to the state ST2 without passing through the state ST1. The processing in the state ST2 of the store instruction is put on hold until the locking of the atomic instruction is released. Although no conflict occurs, the load instruction is put on hold, and accordingly, the processing performance of the computation processing apparatus 104 degrades.

Features and advantages of the embodiments are clarified from the foregoing detailed description. The scope of claims is intended to cover the features and advantages of the embodiments as described above within a scope not departing from the spirit and scope of right of the claims. Any person having ordinary skill in the art may easily conceive every improvement and alteration. Accordingly, the scope of inventive embodiments is not intended to be limited to that described above and may rely on appropriate modifications and equivalents included in the scope disclosed in the embodiments.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A computation processing apparatus that is able to execute a plurality of threads, the apparatus comprising:
a cache including a plurality of ways which respectively include a plurality of storage areas identified by index addresses; and
a processor coupled to the cache and configured to:
determine a cache hit;
hold a way number and an index address which identify a storage area holding target data of an atomic instruction executed by any one of the plurality of threads;
determine a conflict between instructions in a case where a pair of the way number and the index address match a pair of a way number and an index address that identify a storage area that holds target data of a memory access instruction executed by an other one of the plurality of threads; and
suppress input and output of the target data of the memory access instruction to and from the cache when determining the conflict.

2. The computation processing apparatus according to claim 1, wherein the processor
holds store-target first data of a store instruction and a first flag to be set when the cache hit of the store instruction occurs;
holds the first data and the first flag transferred from the first buffer as second data and a second flag;
controls the first buffer and the second buffer; and,
in a case where the first data and the first flag that is set are held in the first buffer and the conflict is determined, suppresses transfer of the first data and the first flag to the second buffer until the conflict is resolved.

3. The computation processing apparatus according to claim 2, wherein
the processor
transfers, in a case where the first data is held in the first buffer and the conflict is not determined, the first data and the first flag to the second buffer as the second data and the second flag,
repeats, in a case where the second flag is in a reset state, the determination until the cache hit occurs, and,
in a case where the cache hit is determined and the conflict is not determined, sets the second flag and stores the second data in the cache.

4. The computation processing apparatus according to claim 2, wherein
the processor
suppresses, when determining the conflict when the first data and the first flag are transferred from the first buffer to the second buffer, setting of the second flag until the cache hit occurs even in a case where the first flag is set.

5. The computation processing apparatus according to claim 3, wherein
the processor resets the second flag when the atomic instruction is executed.

6. The computation processing apparatus according to claim 3, wherein
the processor stores the second data in the cache when not determining the conflict and the second flag held by the second buffer is in a set state after data has been transferred from the first buffer to the second buffer.

7. A method of processing computation of a computation processing apparatus that is able to execute a plurality of threads, the method comprising:
determining a cache hit of a cache including a plurality of ways which respectively include a plurality of storage areas identified by index addresses;
holding a way number and an index address which identify a storage area holding target data of an atomic instruction executed by any one of the plurality of threads;
determining a conflict between instructions in a case where a pair of the way number and the index address match a pair of a way number and an index address that identify a storage area that holds target data of a memory access instruction executed by an other one of the plurality of threads; and
suppressing input and output of the target data of the memory access instruction to and from the cache when determining the conflict.
